(19) United States
(12) Patent Application Publication
(10) Pub. No.: US 2025/0003572 A1
(43) Pub. Date: Jan. 2, 2025

(54) Manually Steered Remote Spotlight Compensating Beam Parameters Including for Variations in Throw

(71) Applicant: Michael Callahan, New York, NY (US)

(72) Inventor: Michael Callahan, New York, NY (US)

(21) Appl. No.: 18/886,405

(22) Filed: Sep. 16, 2024

Related U.S. Application Data
(63) Continuation-in-part of application No. 17/508,194, filed on Oct. 22, 2021, now Pat. No. 12,117,163.
Application No. 17/508,194 is a continuation of application No. 17/069,054, filed on Oct. 13, 2020, now Pat. No. 11,187,398.
Application No. 17/069,054 is a continuation of application No. 15/945,987, filed on Apr. 5, 2018, now abandoned.
(60) Provisional application No. 62/481,749, filed on Apr. 5, 2017.

(51) Int. Cl. F21V 7/00; F21S 8/08; F21S 10/00; F21S 10/06; F21V 14/02; F21V 17/02; F21V 21/15; F21V 21/30; F21W 131/406; F21Y 115/10; G02B 26/08; G02B 26/10; H01B 7/00; H01B 9/00; H01R 24/28

(52) U.S. Cl. CPC F21V 7/00; F21S 8/08; F21S 10/00; F21S 10/06; F21V 14/02; F21V 17/02; F21V 21/15; F21V 21/30; G02B 26/0816; G02B 26/101; H01B 7/0045; H01B 7/009; H01B 9/003; H01B 9/006; H01R 24/28; F21W 2131/406; F21Y 2115/10

(57) ABSTRACT

Improvements are disclosed to spotlights changing beam direction during use so as to reach one or more subjects different distances away. One aspect of the invention automates the adjustment of beam parameters including beam size, shape, edge, and intensity to manage the effects resulting from causes including changes in fixture-to-subject distance/“throw”, focal length, and color/color correction. In one aspect, changes in beam elevation are used to calculate corrections for changing dstance/throw without the requirement to determine the location of the fixture or actual change in distance.

### BACKGROUND OF THE INVENTION

This application is a continuation-in-part of U.S. application Ser. No. 17/508,194 filed Oct. 22, 2021, which is a continuation of U.S. application Ser. No. 17/069,054, filed on Oct. 13, 2020, which is a continuation of U.S. application Ser. No. 15/945,987, filed on Apr. 5, 2018, which claims benefit of U.S. Provisional Patent Application No. 62/481,749, filed on Apr. 5, 2017, the entire disclosures of which is hereby incorporated by reference.

The field of art is spotlights changing beam direction during use so as to reach one or more subjects that are different distances away.

The “followspot” is one such fixture type, dating from the late 1800s, adapted to illuminate a performer or other subject as they move about, and to successively light subjects at different locations, by the agency of a human operator physically re-pointing the fixture in real time. In addition to changing direction, such fixtures include an optical system imaging an internal aperture whose size can be mechanically altered to produce a corresponding change in beam size, plus mechanisms to vary intensity and to move color and other filters in and out of the beam.

The requirement that, to adjust it, a human operator must “lay hands” directly upon the fixture limits traditional followspots to positions at which that operator can also be safely accommodated. This has required providing, in venues for performances and events, booths and platforms in their upper reaches. In other circumstances, balconies will be used, or temporary platforms must be suspended from an overhead building structure by lifting motors. In outdoor situations, temporary scaffolding towers are built.

These necessary accommodations, in turn, often dictate distances between a followspot and its subject (“throws”) of hundreds of feet, requiring large fixtures built around high-powered light sources and producing very narrow beams. U.S. Pat. No. 2,950,382 to Hatch discloses the Strong Electric Supertrouper, long an industry standard in both carbon arc and xenon-based versions. More compact “short throw” followspots are used in relative proximity to the subject, such as from overhead positions on trusses, albeit with complications of steep angle, operator access and safety.

Such costs and limitations have long made desirable fixtures capable of following subjects under remote control with the operator at a different, more convenient location. Advantages include the ability to locate the fixture more flexibly and optimally, including at a shorter distance from the subject, permitting the use of a smaller unit of lower power.

In 1902, a fixture adapted as a remote followspot was disclosed in U.S. Pat. No. 819,511 to Sohlberg. In 1935, Levy disclosed a remotely controlled mirror for the purpose in U.S. Pat. No. 2,054,224. The Cyklops unit by Fackert and Graf and the Cameleon Sarl TeleScan were introduced in the 1970s.

The development of “automated” lighting systems, as first disclosed in U.S. Pat. No. 3,845,351 to von Ballmoos et al, advanced remote followspots by evolving fixtures motorized for remote adjustment of beam size, shape, azimuth, elevation, intensity, and color; some eventually improved in output and performance sufficiently for use, with an appropriate manual controller, as followspots.

Whether attended or remote, followspots have always presented issues. One being the effects of differing distances between the fixture and the subject. It is basic physics that, absent compensation, beam diameter will increase proportionately with distance and intensity will decrease by the square. A change of 3:1 in distance/“throw” produces a similar change in beam diameter and a 9:1 change in brightness.

For decades, followspots have been the primary (if not the only significant) source of light on the principals in performances and events of many kinds whose filming or taping has increasingly been one object-if not the purpose. Even without this intent, “video-magnification”, in which real time close-ups of the principals are shown on giant screens for the audience, has also become a staple. The cameras used, unlike the human eye, are incapable of handling wide variations in brightness on their subject, especially amidst more stable illumination of the general scene. Light levels on a subject must be carefully maintained within narrow limits—and despite changes in fixture-to-subject distance.

For a given light source and optical system, many factors determine beam size and light level at a given distance/“throw”.

Followspots include optical systems having a focal length adjustment. In traditional attended designs such as Hatch and its successors, the system is comparatively simple and limits adjustment range to approximately 2.5:1. Fixtures designed for automated lighting typically have more sophisticated optics with focal ranges on the order of 8:1, which produces a change in light level at the subject over a 38:1 range. As such, changing the focal length to re-size the beam soon requires compensating adjustment(s) to maintain a light level. Conversely, intensity changes resulting from changing focal length can be of use in setting light levels—provided that the beam remains large enough to cover the subject.

Such fixtures also include “douser” or “fader” mechanisms, which mechanically reduce beam intensity by blocking some portion of the source's output. (Carbon arc, xenon, and discharge light sources not being possible to dim across a useful range using power control). On traditional followspots, an operating lever projects from the housing for the operator, but its adjustments are neither accurate nor repeatable.

Fixtures also include “irises”, variable diameter apertures imaged by the optical system, for varying beam sizes over a typical 6:1 or greater size range. In contrast to adjusting focal length, changing beam size with an iris has little impact on intensity. However, in a vari-focal fixture, using the iris to reduce beam size when a longer focal length remains available represents a loss in efficiency, of that fraction of light source output that could have been in the beam but will instead be blocked by the iris.

Beam size and light level at a subject are hardly the only parameters impacted by varying distance. The edge sharpness of the beam, as determined by focal length, aperture, iris, shutters, and/or template, is finalized by a mechanical adjustment of the optics for the throw. Changing throw distance will, undesirably, change sharpness.

Correcting beam parameters for these effects, however important, has yet to prove practical in prior art attended followspots because the number of physical adjustments necessary is impractical to perform simultaneously, much less accurately. Referring to Hatch, its operator must maintain visual contact with the subject while manually steering the hundred-pound fixture head so as to keep the subject centered in the beam. To maintain beam consistency on a moving subject, the operator could also need to adjust focal length with lens handle 176, iris via 224, brightness with 268, and edge sharpness using 161. Even were this possible, an operator's judgment of beam brightness is not accurate enough for the limited exposure tolerances of cameras.

Remote followspots have made beam correction both more important and more difficult.

Desirably, they allow locating the fixture at a shorter distance/throw from the subject than is typical for an attended unit, but reducing distance increases the range/ratio of distance/throw variation between different subject locations. This is particularly true for performances and events spread over large areas and/or on multiple stages. A remote fixture's throw can change in seconds by several multiples—with dramatic impact on beam size, light level, and edge.

Motorized fixtures, whether designed for followspot use or not, provide remote adjustment of many beam parameters. Front-end controllers adapting them for followspot use (e.g., U.S. Pat. No. 9,593,830 to Conti et al and U.S. 2018/0292809 to Farnik et al) include a two-axis means to adjust pan and tilt, and additional controls to adjust other parameters. Yet, no more practical is the simultaneous manual adjustment of all the parameters necessary to correct the beam for the effects of changes in throw.

Such fixtures, accepting digital protocols such as DMX-512 can, in the appropriate data distribution infrastructure, accept desired parameter values from multiple sources, so that parameter control can be divided between a lighting console and the followspot controller. For example, pan, tilt, iris, and local intensity from the controller, and focal length, color, edge, and supervisory intensity from the console. However, simultaneously compensating multiple fixtures is no more practical, particularly when the console operator is also responsible for hundreds of other fixtures—unless the need for such corrections is predictable and they have previously been determined and stored. Even when such preparation/storage is possible, things change. Plans go awry. And stored values become no longer appropriate.

The use of remote followspots for major productions of many kinds (e.g., a dozen on a major awards show) has therefore demanded elaborate systems and strategies to chase their issues, including those resulting from variations in throw distance.

Referring to FIG. 1, four motorized fixtures 11F, 12F, 13F, and 14F are illustrated, each with an associated controller and operator (e.g., 11C and 11O for fixture 11F). The operator is typically assigned control of fixture pan, tilt, and iris, responsive to verbal instructions from the lighting designer 20 via a headset/intercom system (e.g., 20H and 11H) connecting them. The balance of followspot control is with a separate console 22C and dedicated operator 22O via a digital connection (e.g., 11D and network 19). Non-followspot fixtures in the lighting system are controlled by at least one other console 21C by its operator 21O.

Camera sensitivity to subtle differences in not just light level but spectral distribution require precise control of both followspot color temperature and green/magenta balance, such that, despite variations in the fixtures and their bulbs, beams match each other and are appropriate to the rest of the lighting design.

Given such sensitivity, only careful measurements using sophisticated light and color meters can be relied upon, requiring that such a meter 24 be carried by a lighting assistant 23 to a location largely free of competing ambient light and a followspot operator aim their fixture's beam at the meter 24. Assistant 23 then reports the color temperature and green/magenta balance to the followspot console operator (“FCO”) 22O via their headsets 23H and 22H, who remotely adjusts filter mechanisms in the fixture. The process must be repeated for each fixture. Such “color correction” changes beam intensity.

To determine the light level on a subject at a given location, the assistant 23 must go to that location, meter it, and report on the result of current fixture condition, throw, correction, and other adjustments. Typically, the lighting designer 20 will have decided on a desired starting level. Based upon meter readings from the assistant 23, the FCO 22O will adjust fixture intensity to reach that level and store the adjustments necessary. Each followspot will require such adjustment and storage for each significantly different location it might be called upon to reach.

In so doing, choice of focal length must be considered. Focal length determines the maximum range within which iris adjustments alone can size the beam. Too short a focal length for the anticipated range of throws will sacrifice both intensity and minimum beam size. Too long will result in a beam that fails to cover the subject at shorter throws. Yet, until restored to the previous value, changes in focal length during use will change intensity, and therefore light levels at previously determined and stored locations. Focal length (“zoom”) and iris settings interact to determine beam size, but they are separately and independently controlled and, in the case illustrated in FIG. 1, that control is divided between two persons.

Such adjustments are time and labor consuming. Typically, however, they are only the first of many.

During rehearsals and the performance/event, independent of compensating for variations in distance/throw, a lighting designer will change brightness and/or color correction for reasons including different subjects, their complexions and clothing, aesthetics, and the contribution of other sources. Camera adjustments (e.g., “shading”) by the video engineering staff can require changes. For a performance or event this can require determining, storing, and organizing into a complex cue structure a succession of changes for each followspot/fixture in beam intensity, size, color, and edge for these reasons, as well as to compensate for differences in distance/throw.

Despite such preparation as has been practical, followspots are called upon to light subjects and locations not anticipated and for which compensated adjustments have been determined and stored. Subjects will move continuously from location to location at different speeds and over substantial distances, resulting in large changes in beam size, light level, and edge for which real time compensation by either the operator or FCO 22 is impractical.

There are also several different approaches to remote followspot control in current use, and users can have distinct preferences between them.

One, first disclosed in U.S. Pat. No. 4,527,198 to the applicant, attaches a video camera to the fixture such that its image remains coaxial with the beam. By maintaining the subject centered in that image, the operator keeps the subject centered in their beam.

More complex approaches include:

In another, a camera is separate and independently motorized. The operator keeps the subject centered in the image and angles for one or more fixtures are computed to intersect there.

In another, a camera is fixed in direction with a wide, overall view shared with several operators, each steering a different fixture. The current location of each fixture's beam is computed and displayed as a unique symbol in the shared image, each operator steering their symbol (and thereby beam) to their subject.

In all three cases, the beam angles of multiple fixtures at different positions might be computed so as to intersect at the same subject.

All require different, dedicated hardware and software. Different expertise is necessary to configure and maintain them. And for some, the computational workload has resulted in delays in response and in crashes.

In sum, it has long been desirable to achieve automatic and continuous compensation in beam parameters such as size, intensity, and edge, including for changes in throw/distance.

A practical method equally applicable to all control approaches in current use, without significant workload for or modification to their hardware or software, nor requiring expertise to configure and maintain is the ideal.

### BRIEF DESCRIPTION OF THE DRAWINGS

FIG. 1 illustrates a prior art method of managing manually steered remote fixtures used as followspots.

FIG. 2 illustrates a motorized fixture as has been used as a remote followspot.

FIG. 3 illustrates elements of a typical fixture internal to the head.

FIG. 4 illustrates elements of a fixture associated with beam direction.

FIG. 5 illustrates in plan perspective the horizontal offset between a motorized fixture and example locations of subjects to be lit.

FIG. 6 illustrates in elevation the horizontal and vertical offsets between a motorized fixture and two example locations of subjects to be lit.

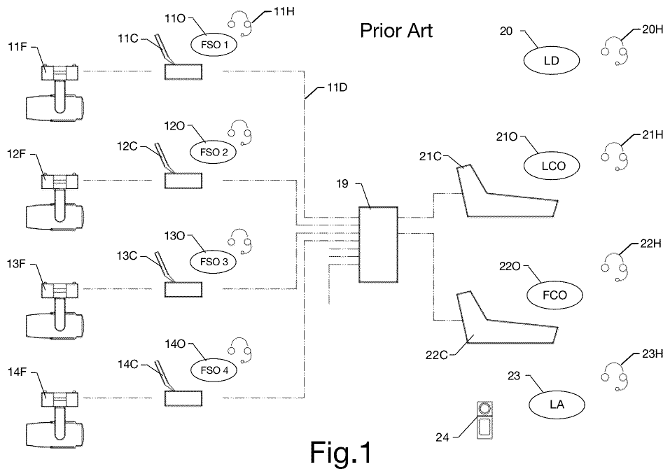

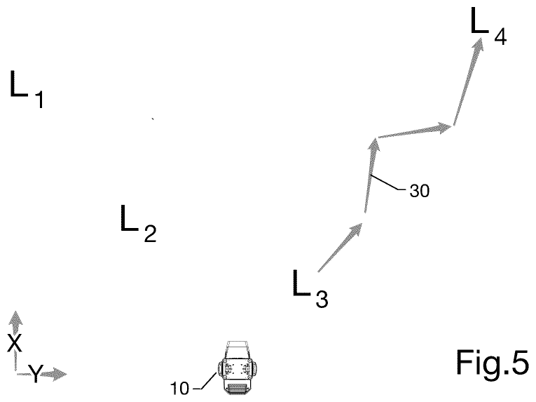

FIG. 5 illustrates in elevation the offsets between a motorized fixture and an example location.

FIG. 7 illustrates in elevation the relationship between offsets.

FIG. 8 illustrates in plan perspective example locations of subjects to be lit and other points at the same beam elevation and throw length.

FIG. 9 illustrates a parameter correction loop responsive to changes in elevation.

FIG. 10 illustrates a parameter correction loop responsive to changes in color.

FIG. 11 illustrates a parameter correction loop coordinating intensity, focal length, and iris to maximize efficiency.

FIG. 12 illustrates the use of prior art cabling to share power and data among a plurality of consumers, such as lighting fixtures.

FIG. 13 illustrates the bundling of power and data cabling.

FIG. 14 illustrates an improved unit that distributes power and data.

FIG. 15 illustrates an improved unit distributing power and data in which

one set of connectors is incorporated in a housing.

FIG. 16 is an end elevation of the improved unit of the prior Figure.

FIG. 17 is a reverse of FIG. 15, showing example strain relief provisions for the captive cables.

FIG. 18 illustrates an improvement wherein the input and output data lines are connected at an intermediate connector.

FIG. 19A is one data-only application of the data distribution technique illustrated in the prior Figure.

FIG. 19B illustrates a “data festoon”.

FIG. 20 illustrates an improved unit that distributes power and data to a consumer that employs the improved data distribution method of the prior Figures.

FIG. 21A illustrates such an improved unit simplifying the distribution of power and data to a plurality of consumers.

FIG. 21B illustrates how a plurality of such improved units simplify the distribution of power and data to a plurality of consumers.

FIG. 22A is one end elevation of a variant unit used for in-line insertion in a cable run.

FIG. 22B is a side elevation of the variant unit of the prior Figure.

FIG. 22C is the other end elevation of the variant unit of the prior Figures.

FIG. 23A illustrates an application of the variant unit of the prior Figures.

FIG. 23B illustrates the application of the units of the various Figures as a line cord supplying a single consumer.

FIG. 24A is a side elevation of a variant unit adapted for consumers having fixed line cords and also illustrating a split housing.

FIG. 24B is an end elevation of a unit illustrating a separable module for data wiring and connectors.

FIG. 24C is a side elevation of the unit illustrated in the prior Figure, with the separable module in place.

FIG. 24D is the other end elevation of the unit illustrated in the prior Figures.

### SUMMARY OF THE INVENTION

One aspect of the invention automates the adjustment of beam parameters including beam size, shape, edge, and intensity to manage changes in them resulting from causes including changes in fixture-to-subject distance/“throw”, focal length, and color/color correction. In one aspect, changes in beam elevation are used to calculate corrections for changing throw without the requirement to determine the location of the fixture or actual change in distance.

### DETAILED DESCRIPTION

Useful adjustments difficult or impossible to perform with prior art manually steered fixtures can be automated.

For example, by mapping a followspot's location in 3D space, azimuth and elevation sensed from its current direction can be converted into an estimate of the distance/“throw” to the subject lit (based on a presumption of a level surface/“Z-axis”, or as modified by a 3D model of a stage or other area that accounts for varying terrain height/“Z”). “Throw” calculations can then be used to generate adjustments/corrections to parameters, including to beam size and intensity, that maintain substantially constant absolute values at the subject despite changes in throw (or to produce another desired outcome). Adjustments can be specified as an absolute value at the subject, for example, as a diameter in feet or intensity in footcandles, including with calibrations on a manual control or entry or recall of a numeric value (including from an external controller). The fixture will then be adjusted to produce the specified size and intensity (and/or edge sharpness, or other value) at the current throw, and will maintain it (if so desired) when the throw changes (including compensating for the different conic sections resulting at different incident beam angles).

Including in (but not limited to) such a system, fixture focal length, iris diameter, and dowser settings can be optimized for specific purposes, such as maximizing intensity for a given diameter or range of diameters at a given throw. For example, maximizing focal length before resorting to reducing iris size. Parameter values can also be associated with locations and zones, resulting in specified values there.

“Spatial awareness” can also be used for other purposes. Boundaries can be defined that trigger automatic dousing of the beam to prevent undesirably lighting pre-defined “no-go” areas. When shutters are provided to trim one or more edge of the beam, their blades can be rotated to maintain a defined relationship, such as being parallel to a stage edge, when the fixture is located off-axis, and to be automatically rotated and inserted so as to crop the beam at such boundaries.

When two or more subjects, each lit by one or more fixture, move close together, the “piling up” of multiple beams produces an increase in total light levels that is undesirable for video. Because the disclosed system “knows” subject and fixture locations and commanded beam characteristics, the intersection/overlap of multiple fixture beams can be modeled, as can the resulting cumulative intensity, and one or more fixtures be automatically adjusted in brightness, size, edge, and/or shape to compensate (including with assigned priorities, such as based on the relative locations of the subjects, for example, the fixture assigned to the closer subject maintaining its values, while others “defer”).

Calculating fixture location in 3D space to produce the azimuth and elevation values necessary for beam intersection at a given point/subject has been known since the Syncrolite system of Keny Whitright in the early 1980s. Such techniques are also used in systems that automatically follow performers wearing emitters, such as Whitright's AutoPilot system as introduced in the early 1990s.

Followspot location and direction can be determined with precision by equipping the head with a pointing laser. In setup, the laser is aligned manually (or detected) on two or more targets that are a specified (or entered) displacement apart. Commercially available laser rangefinders can also be used in calibrating the fixture location, supplying not only the included angles between the two targets, but the length of the long sides. They can map 3D terrain, including by automated scanning. Terrain models can be linked to a scenic automation control system to update topology, and the location coordinates of a subject that is or is on a moving scenic element supplied. One or more “read heads” with photometric sensors can be placed for measuring intensity, color temperature, and other beam variables. Aiming (manually or automatically) a fixture's beam at one such sensor can remotely provide photometric data, including for adjusting values. The system can scan the beam across the sensor, not only to map deviations across the beam, but as an aid in locating the fixture in space and in modeling its response to input values. The sensor can itself be mounted on a motorized support to orient automatically towards the fixture being measured. A wireless read head can be “walked” through an area of interest to map light levels and characteristics and the contributions of individual fixtures determined by modeling and/or varying their level. Such data can be use to automatically vary the beam characteristics of one or more fixtures at points in the area and/or in transits within it to achieve desired objects.

Azimuth and elevation data from a lighting fixture that is manually pointed by an operator at a subject (whether physically with “hands on” the fixture or using remote motorized control) can be used to determine and adjust the azimuth and elevation of beams from other, unattended lighting fixtures required to intersect the same subject.

Thus, one manually steered followspot can also be used to steer multiple fixtures motorized in pan and tilt such as, for example, are supported above the performance area, replacing short-throw “truss” spots and their operators, with many benefits.

Multiple manually steered followspots can, when desired, share coordinates to synchronize their movements.

Desired parameter values can be selected in real time by an operator and/or commanded from a supervisory controller. The next desired value(s) can be preset or “loaded” from an external device, an onboard control, or a stored value with execution triggered independently, either by the operator or from a supervisory level, including synchronization with non-followspot fixture controllers.

The speed of parameter changes initiated by an operator can be subject to values dictated by a supervisory controller. For example, a DMX-512 value can specify the rate or duration of a parameter change that is triggered by the operator, which value (and therefore rate or duration) can be changed over time.

Parameter change duration can also be made conditional on whether the beam is visible.

When the fixture beam is “doused” /off, adjustments made in beam parameters are, of course, not visible. When the beam is visible, adjustments made in haste can be distracting. Pending changes in parameter values (such as in size or color) that are desired once a fixture has been redirected to a new or different subject (a “pickup”) can be triggered automatically when the fixture's beam is doused during the change in direction. Similarly, an abrupt change/acceleration in direction can be interpreted as a quick move to another subject, and the beam automatically faded out, ready to restore automatically on deceleration or by the operator on arrival at the new position.

Rather than depending solely upon a supervisory controller to determine and store desired beam parameters for later reuse, an operator can be allowed to use their local controls to set values, and the desired values can be uploaded for storage and/or stored locally, referenced to another value used as an identifier/reference. The identifier (such as a known “cue number” or time code, including as might also be used in non-followspot lighting control) can be supplied from the supervisory level, including by the use of values in DMX-512 slots. Thereafter, an appropriate cue number, time code, or DMX value from the supervisory level (or entry locally) can access those stored values.

The succession of beam directional values (whether native azimuth and elevation angles for a fixture or its subject's spacial coordinates) that are required to “follow” a subject manually can be stored for later display and recall, and other beam parameter changes stored with them. A previous “pass” of manually-steered beam motion (i.e., the beam's path) can be recalled for display, editing, and/or re-execution, and the profiles of other beam parameters adjusted both for such stored recall and during subsequent manual passes along the same or similar path at the same locations. Values can be referenced to time, cue numbers, and/or an externally generated time code.

Data in addition to parameter values can be stored and/or exchanged. For example, where the fixture or its controller has a video display, the operator can be presented with a stored picture/still to identify or remind them of their intended subject. Text descriptions (“cue sheets”) can be presented to the operator, as well as being entered and edited both locally and over a network including at the supervisory level, such that a database of both parameter values and notations/commentary can be developed and shared.

Such capabilities have long been possible, and entirely within the industry's state of the art.

### Parameter Compensation for Throw

For purposes of this description, the divergence of the beam, measured in angular degrees, is “beamspread” and its diameter (in feet or meters) at the current subject “size”. The power of the beam leaving the fixture, typically measured in candela, is “intensity”, and the brightness at the subject (in footcandles or lux) will be “light level”. The sharpness of edges in the beam at the plane of the subject will be “edge”.

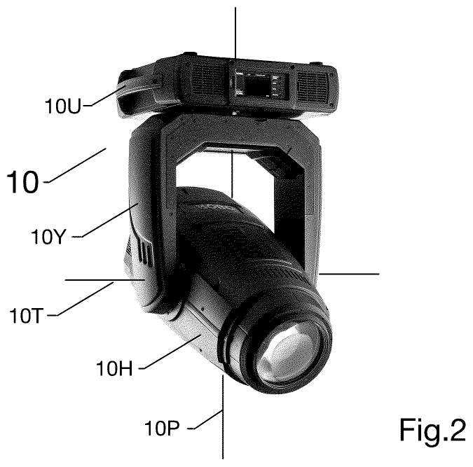

FIG. 2 illustrates a motorized lighting fixture 10 such as has been used in remote followspot systems, including a head 10H, containing the light source, optical system, and mechanisms modifying the size, shape, color, and intensity of the beam produced. Head 10H is suspended between the arms of a yoke 10Y and motorized for rotation about a nominally horizontal tilt axis 10T. The yoke 10Y, in turn, is suspended from an “upper enclosure” 10U (typically housing power supplies and electronics) for rotation about a nominally vertical pan axis 10P, which is orthogonal to the tilt axis. Upper enclosure 10U is used in suspending the fixture from a structure or as a base resting on a surface below.

The distance between a fixture and a subject (its “throw”) is determined by the horizontal and vertical offsets between them. FIG. 5 illustrates in plan perspective the relationship between a motorized fixture 10 and several example locations L₁-L₄ at which its beam will need to be directed. In the case of locations L₃ and L₄, a subject will begin at location L₃ and move to location L₄, during which they are to be continuously lit by fixture 10, preferably while beam size, edge, and light level remain the same.

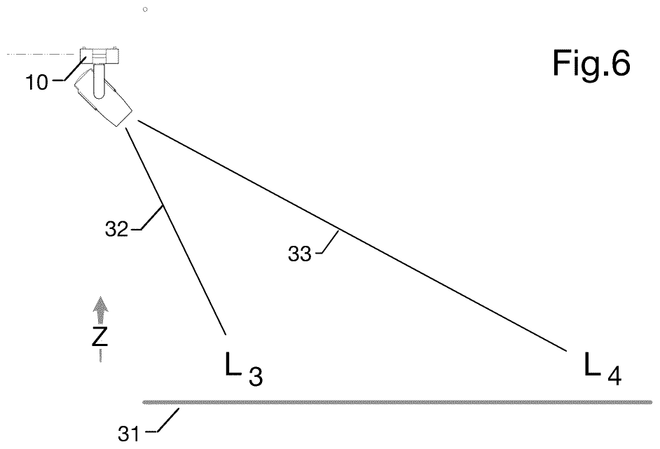

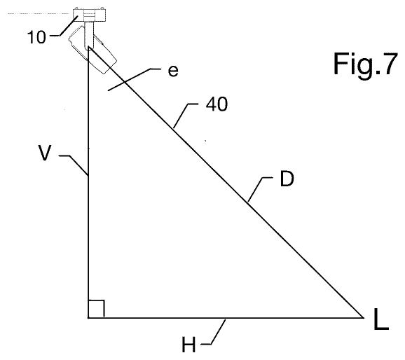

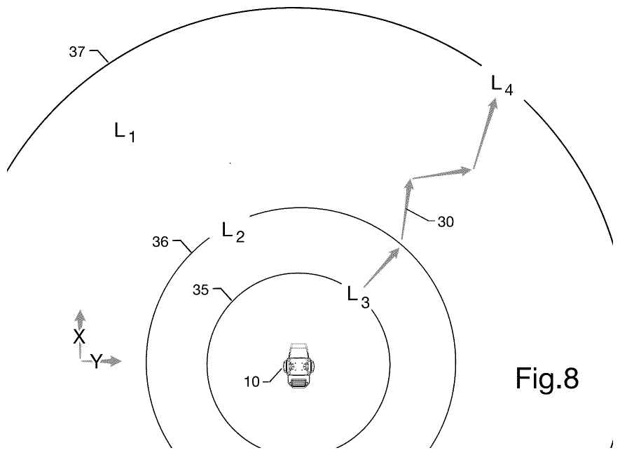

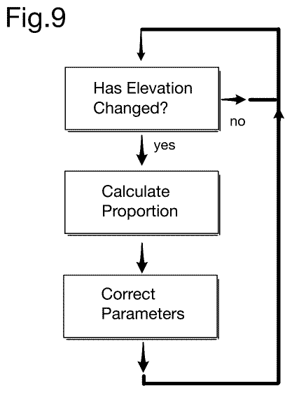

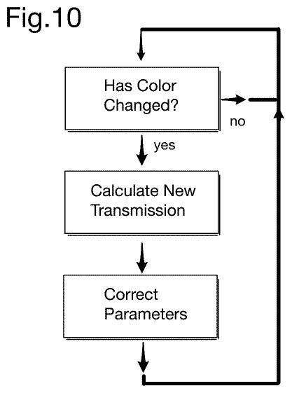

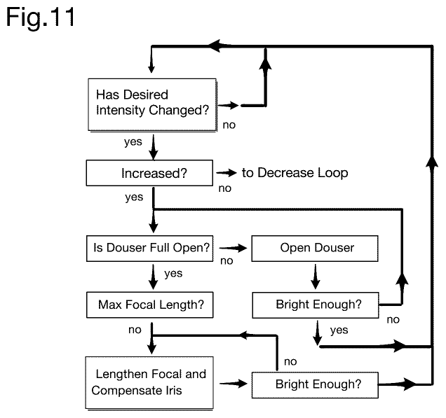

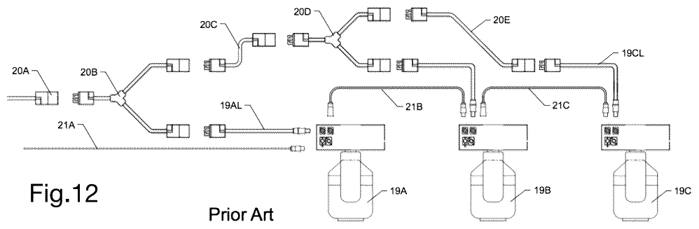

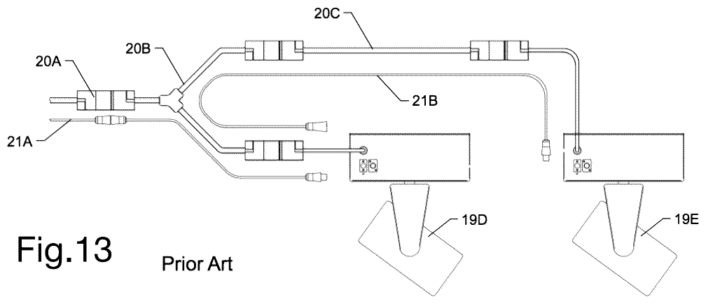

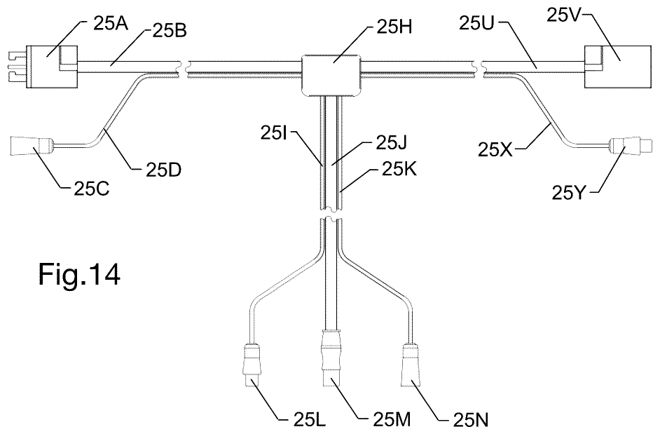

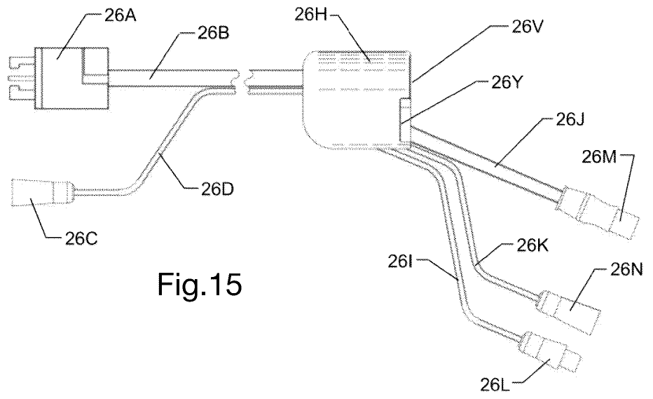

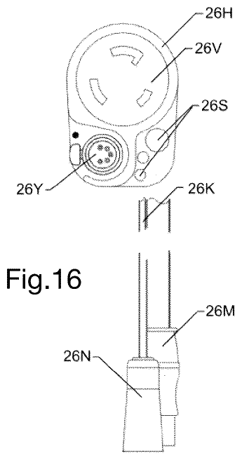

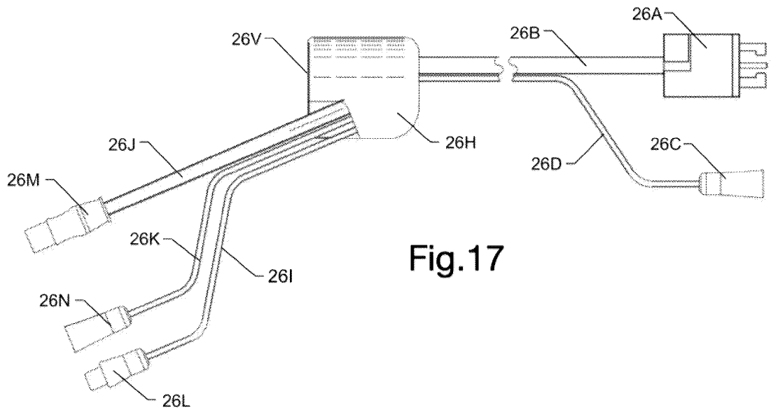

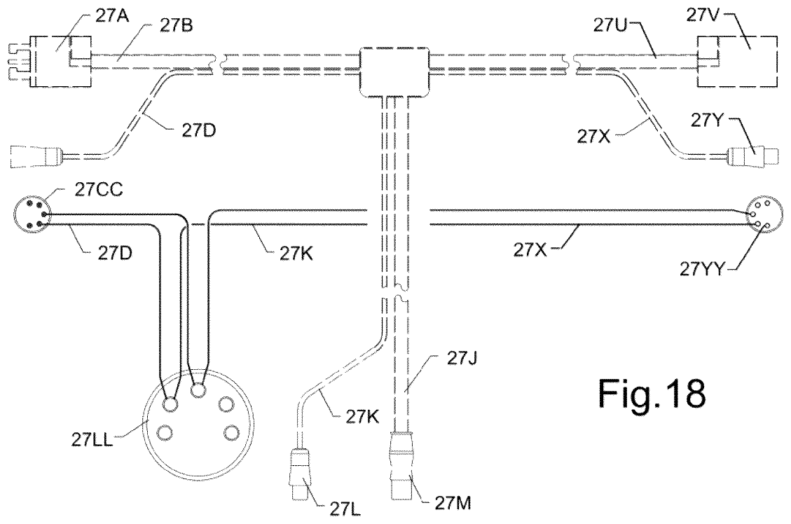

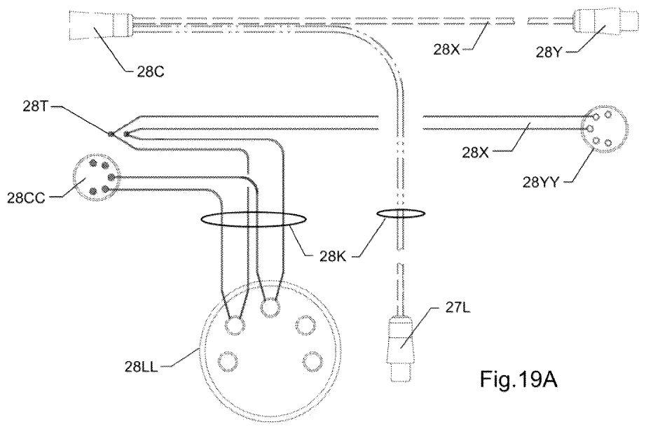

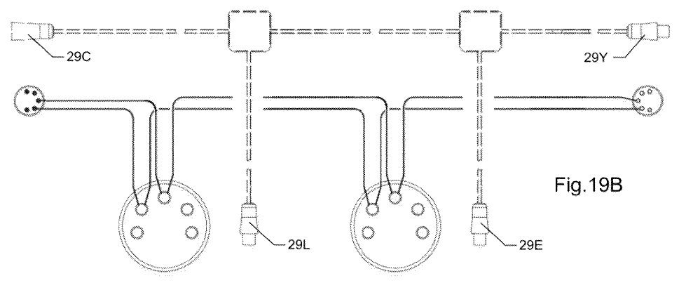

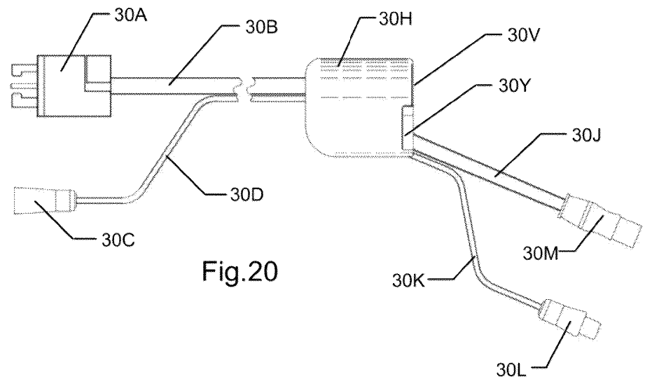

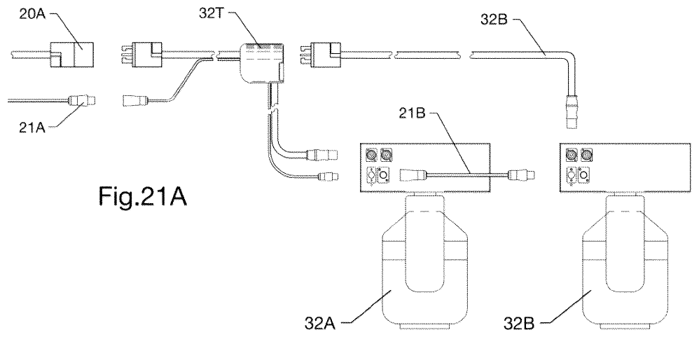

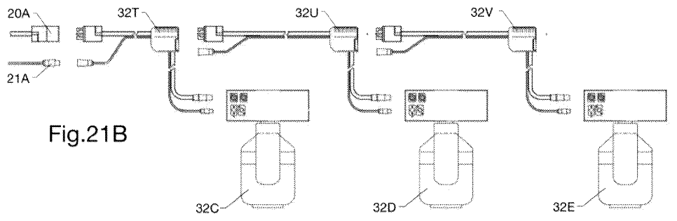

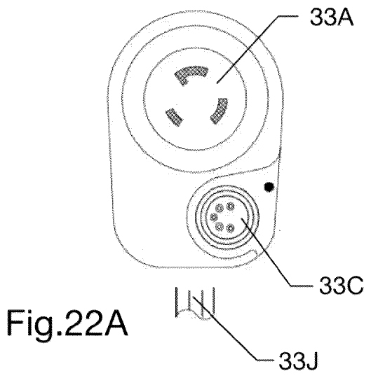

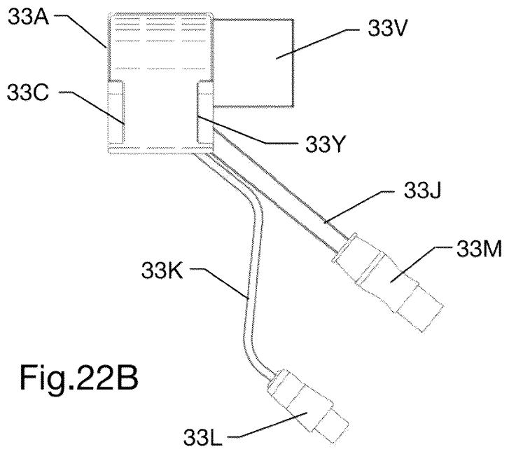

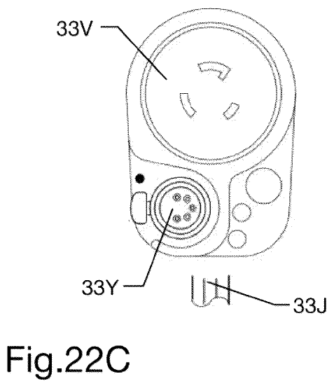

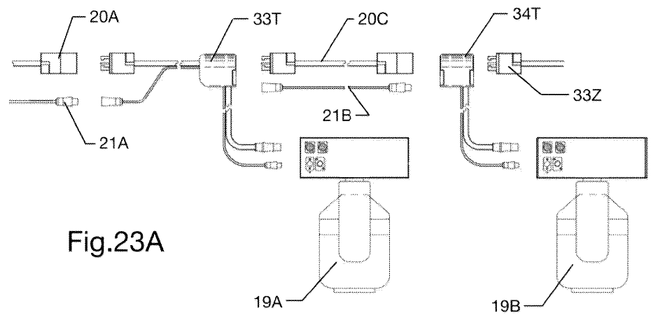

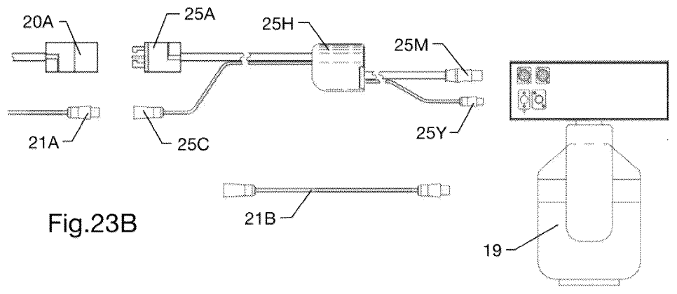

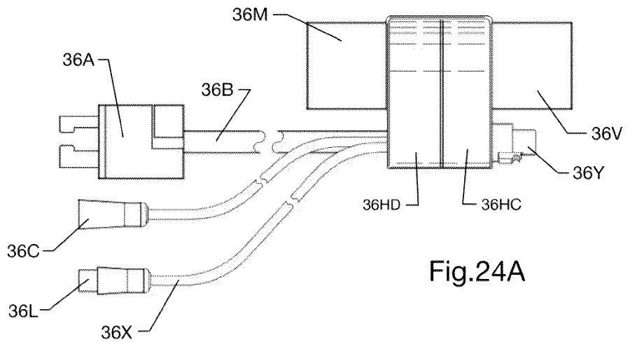

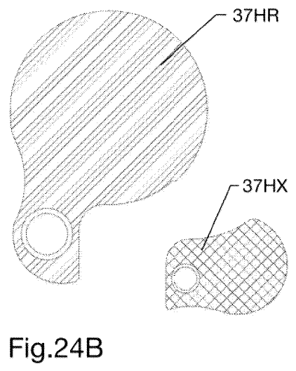

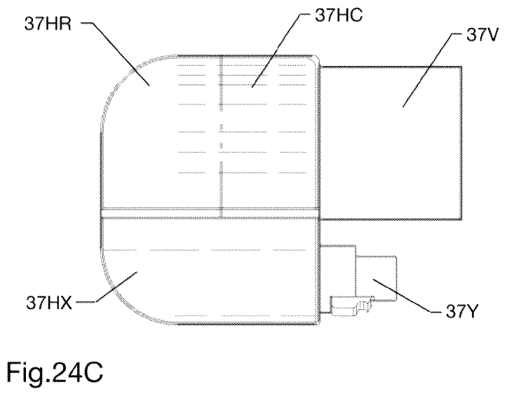

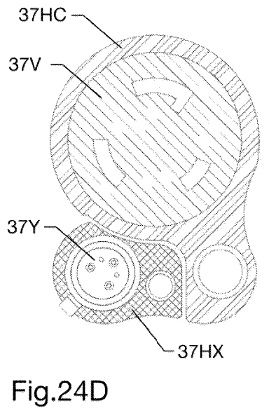

FIG. 6 illustrates the relationship in elevation between motorized fixture 10 and example locations L₃ and L₄. As seen, the distance or throw 32 between fixture 10 and a subject at location L₃ is substantially different than the distance 33 between fixture 10 and location L₄, with undesirable effects on beam size, light level, and edge. This is particularly difficult to correct when, as in this example, a subject must be “followed” /lit continuously while distance/throw changes—still more so when (as illustrated by path 30) changes speed and/or direction.

In one solution, a 3D model of the space is constructed and the fixture located in it. An operator steers the fixture to track/follow the subject. The beam angle values so generated are used in the 3D model to compute the current distance to the subject, which will determine the corrections necessary to maintain the same beam size, light level, and edge at the subject when distance changes.

This, however, requires entry/calibration of the fixture location and imposes other practical burdens.

Another approach is simpler.

Referring to FIG. 8, an illustration in plan, fixture 10 is shown, again with example subject locations L₁-L₄. Referring to FIG. 7, an elevation, it will be seen that the vertical offset between the fixture 10 and a subject at location L and the horizontal offset between the two form side V and side H of a right triangle 35. The beam forms the hypotenuse D, the “throw” distance being its length. The included angle e formed at the intersection between the vertical side V (i.e., the fixture height/offset above the subject) and the hypotenuse/beam D is beam elevation.

In one example, reaching location L₃ of the prior Figures requires a 53-degree included angle e and produces a hypotenuse/throw D of 50 feet. Reaching location L₄ requires an included angle e of 78 degrees and produces a hypotenuse/throw D of 150 feet. An uncompensated beam with size and light level adjusted for location L₃, on reaching location L₄, will have increased 300% in size and fallen 90% in level. But, given that the height of fixture 10 above the horizontal plane of subject locations remains constant, only the change in beam elevation/included angle e is necessary to calculate the corrections to size, light level, and edge required to maintain them constant at the subject.

In one method, any arbitrary value for side V length will suffice using V/cos (e) to produce side T lengths for both angles e. The ratio of resulting side T lengths/throws becomes the basis for correcting parameter values. FIG. 7 illustrates a loop continuous correcting. Neither the actual lengths of the horizontal H or vertical offsets V of the fixture relative to the subject nor the actual throw/distance D between them are necessary—hence no calibration or 3D modeling.

Returning to FIG. 7, the beam elevation/included angle e necessary to reach a subject at location L₃, if maintained while azimuth is then changed, will define a circular conic section at the plane of subject locations, a portion here shown as arc/path 35. All locations along the same beam elevation that produces arc/path 35 will be at the same distance/throw from fixture 10. Similarly, all locations along the beam elevation defining arc/path 36 will be at the same distance/throw, as will be those along arc/path 37. Hence, so long as both beam elevation and beam parameter values are available, distance/throw compensation can be made for any combination of beam angles and therefore any subject location.

Automatic parameter compensation for throw changes can thus be determined entirely in the fixture with only updated software. Or in a front-end controller. Or a console. Or in an intermediate server or adapter.

Such automatic compensation can readily be made selectable, including by the simple expedient of using a value on one of the DMX-512 or other protocol channels to toggle it on and off.

### Other Compensation

Changes in some beam parameters impact other parameters, including at the same distance/throw. For example changing focal length results in changes in beamspread, intensity, and edge. Changes in color or color correction change intensity. Compensation for such interactions can be made automatic.

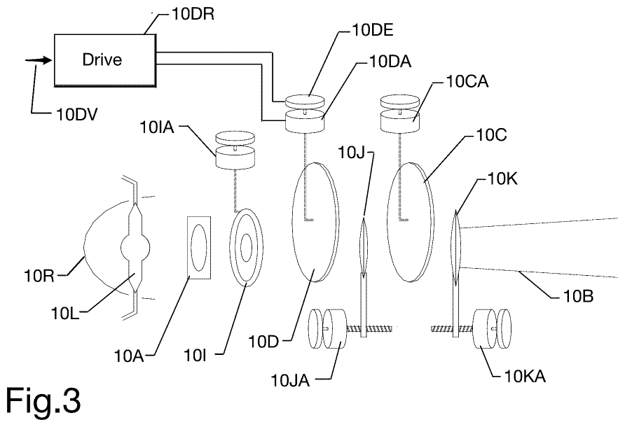

FIG. 3 illustrates some elements of a typical fixture 10 as found in head 10H.

Light source 10L (e.g., a discharge lamp in reflector 10R) is provided with lenses 10J and 10K to form a directional beam 10B. A fixed aperture 10A when imaged imparts a circular shape to beam 10B. An iris 10I provides a variable aperture which, when re-sized, changes the spread of beam 10B. An actuator 10IA drives iris 10I. Lenses 10J and 10K are provided with actuators 10JA and 10JK which displace them along the optical axis to change the focal length of the optical system and shift its focal plane. A variable density filter wheel 10D serves as a “douser”, selectively attenuating the intensity of beam 10B. As is typical for other mechanisms, douser wheel 10D is provided with an actuator 10DA and an encoder 10DE both connected with drive electronics 10DR. Drive 10R receives a value at 10DV corresponding to the desired degree of attenuation and conforms the position of filter wheel 10D to it. (Where the light source is an LED, power control might be employed.) At least one filter wheel 10C is provided for changing the color of beam 10B.

Changes in focal length can, using the fixture's known photometrics, also adjust intensity using douser 10D to maintain light levels, iris 10I to maintain beamspread, and focus (using 10J and 10K) to maintain edge.

Coordination of presently separate but interacting parameters can allow single-value adjustment. Beamspread can be specified with a single “size” value, whose adjustment changes one or more of focal length and iris to adjust beamspread over the entire range possible (in a typical fixture on the order of 50:1), as well as intensity (if desired) to maintain light level. Coordination can prioritize the sequence of adjustments, for example, in the example of FIG. 11, maximizing efficiency by using longer focal lengths before closing iris.

In the case of color correction, the transmission characteristics of the filters used for color correction and green/magenta balance are well documented. As in FIG. 10, adjustment of color temperature with one or more filters (e.g., filter 10C) can include a compensating change in intensity to maintain the same light level at the subject. Thus, real time adjustments made for a particular subject will result in neither a distracting change in intensity nor require intensity correction. Similarly, colors used for effect, which have still lower transmission, can be compensated in whole or in part.

### Absolute Values and Distance/Throw Calculation

Whether for an attended or remote followspot, a given parameter value represents no more than one point in the total range permitted. Its effect on the beam at a given subject location/throw is not now predictable by the user, much less when multiple parameters interact. This is long-standing issue, including when aiming the beam at a new location while it is off/“doused”, because beam variables can't be accurately pre-set. Approximations are made, but the results will first be seen only when the beam is turned on—and by everyone.

Although, as described above, changes in beam elevation can be used to maintain a chosen size, light level, and edge at different distances/throws, it does not permit accurately presetting them in absolute terms (for example, in feet or footcandles).

However, if the height of the fixture above the subject (i.e., the length of side V) is available, then the combination of it and the included elevation angle e allow quickly calculating both the horizontal offset and the throw/distance in feet or meters. Using a fixture's documented photometrics, the absolute result (for example, diameter in feet and brightness in footcandles) of a given combination of focal length, iris, and douser values at that location's elevation angle (and therefore distance/throw) can be calculated. Thus, desired size and light level values can be input in a controller or console in absolute terms with the assurance that the beam will be preset at those values at any location chosen.

The height of a fixture is a key specification in lighting design, and confirmed by careful measurement during system install. This height value can be supplied by many means, including as a numeric input on a control channel.

Typically, fixtures don't change height during use. However, there has been an increase in doing so for scenic effect, using the electric hoists lifting overhead truss structures to change their height and/or angle. This, however, impacts the accuracy of absolute value calculations.

When fixture height changes during an event or performance, a corresponding updated height value can be provided. Values for different heights can be stored with parameter adjustments and cues used at that height, such that the correct value is automatically applied. In cases where the structure supporting a fixture changes height under the control of an automated rigging system, height information can be obtained from it. This includes by the expedient of using a first set of values readily available in the rigging controller (such as the heights of the electric hoists supporting the structure) with a conversion to the height of the fixtures supported by that structure. In one example, the distance between the hoists supporting a linear structure, the location of a fixture along that length, and its vertical offset below that axis, will suffice to determine fixture height from the heights of the supporting hoists. Thus, individual height (and other) calculations can be made for each fixture without burden to the rigging controller.

Height values can also be updated by pointing the beam at a given target. Returning the beam to the same target after fixture height has changed allows determining the height difference by comparing the included angles e.

A fixture head can also be fitted with a distance measuring means, such as a laser rangefinder, which precisely “shoots” the throw/distance to a given location. (Ideally, one having a wavelength not visible to the eye or camera such that it can be used during a performance or event.) The distance measured represents hypotenuse D, which, with the current elevation angle e, allows instant determination of fixture height. With that calibration, comparison of subsequent elevation changes can be used to update current distance/throw and for other purposes without requiring re-ranging.

Subjects are not always on the same horizontal plane. Vertical offsets in height (such as stages and platforms) on which subjects stand can be determined and entered into a reference matrix or model. For example, by scanning/sampling the terrain with a ranging laser, comparison of current azimuth and elevation angles with measured distance/range can detect and quantify changes in height, generating an accurate 3D terrain model. Steering a minimized fixture beam to the corners and edges of changes in elevation can be used in developing a terrain map and/or to calibrate a map imported from a CAD drawing. Vertical offsets/height changes across a terrain can be manually entered or ranged.

### Fixture Orientation and Pan Axis Correction

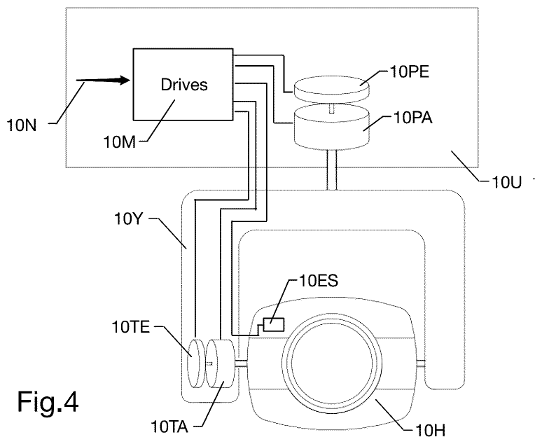

FIG. 4 illustrates some elements of the beam direction components of a typical fixture. Yoke 10Y includes actuator 10TA to rotate head 10H around the nominally horizontal tilt axis 10T. Upper enclosure 10U includes a pan actuator 10PA rotating the yoke about the nominally vertical pan axis 10P. Actuator drives 10M is responsive to values received via input 10N.

For purposes of this description, the radial angle between a fixture head and its yoke about its nominally horizontal axis is referred to as “tilt” and the radial angle about the nominally vertical axis of the yoke relative to the upper enclosure as “pan”. The radial angle of the beam exiting the fixture relative to true vertical is “elevation”, and its angle of rotation about the true vertical axis “azimuth”. Preferably, the fixture is oriented such that its pan axis is aligned with true vertical (is “plumb”).

There are many reasons why this might not be the case, and the problems resulting include with the repeatability of stored beam angles such as in a cue or a subject location recall. The stored values are pan and tilt not azimuth and elevation, so if the fixture's orientation has since changed, it might return to the stored angles, but, by virtue of the fixture's change in orientation, a different beam azimuth and elevation will result.

Fixtures are typically attached with two clamps to an elongated tubular support. The radial angle of attachment relative to the tubing's elongated axis is not indexed and several causes can result in variations. This issue has long been understood, and some users employ either handheld digital angle meters or consult a bubble level attached to the upper enclosure during system setup to check radial angle before the fixture is raised to operating height. Many other factors can change fixture orientation including changes, deliberate and otherwise, in the angle(s) of the supporting structure.

When a fixture is oriented with its pan axis off vertical, the conic section produced at the plane of subject locations will become elliptical rather than circular and beam corrections (because the same fixture tilt angle will result in different throws) less accurate.

Two-axis angle sensing can be incorporated in a fixture's “upper enclosure” to determine how its pan axis is actually oriented. When it is not true vertical, throw compensation can be corrected for maximum accuracy. Direction values incoming from a console or controller can also be referenced to true vertical, assuring that stored values will represent desired beam azimuth and elevation even if the fixture is not so oriented at the time of storage and/or recall.

In another approach, a single axis sensor 10ES can be mounted in (or on) the fixture head such that it reports the true angle of head/beam elevation. As part of typical fixture power-up, a fixture head is commanded through a range of motion in both pan and tilt. Moving the head through at least part of its pan range while maintaining the same tilt angle (i.e., rotational angle relative to the yoke) will quickly establish whether the pan axis is vertical, as the sensed elevation value will not change. If measured elevation does change (or has been commanded to change but is not doing so appropriately), its variance over the commanded pan range will allow determining both the degree and direction of pan axis divergence from true vertical such that angle values can be corrected. This virtual vertical alignment can be made continuous during operation by comparing ongoing commanded elevation changes with the actual changes in measured elevation that should result.

Sensing and correcting to true head elevation angle is also of value with fixtures deliberately hung off vertical from a supporting structure.

An angle sensor can be provided in the yoke.

Sensing actual head elevation can also be used in detecting and correcting another source of beam positioning errors.

In the prior art motion control approach, such as described in U.S. Pat. No. 3,845,351 to von Ballmoos et al, mechanisms adjusting beam parameters are provided with a sensor (e.g., a potentiometer) producing a value corresponding to current position. This absolute value is compared with the desired value received from the front end, and negative feedback used to drive the actuator to null any difference, conforming the mechanism and thereby the parameter to the desired value. This analog approach was supplanted over time in most fixtures with a digital one, the position sensing potentiometer replaced with an encoder. While encoders outputting absolute position have long been available, economy has favored incremental models producing trains of offset pulses from which the amount and direction of rotation can be determined, which then increments and decrements a running total in a counter. To calibrate the value in the counter to actual position, the parameter mechanism is driven against a fixed end stop or through an indexing sensor. Incoming desired adjustment values are then compared to the running total in the counter and the actuator (e.g., a stepper motor) driven to rotate by an amount assumed appropriate to bring the two into conformity. While seeming similar to analog negative feedback, factors including contact between the yoke or fixture head and objects nearby such as cables and the supporting structure (as well as friction and inertial effects) can result in lost motion. The running total, however, will still reflect the assumption that the commanded movement has been completed although a discrepancy has arisen. Such errors can accumulate. When the effect becomes visible, correction requires a forced reset to recalibrate of the fixture, taking it offline. The addition of actual elevation sensing provides a true elevation value, which can constantly be compared with the assumed value and the latter corrected to account for lost motion.

Adding sensing or other capabilities to a fixture head 10H is simplified in fixtures housing motor drives for at least some parameters in it, as power and data communication links with the upper enclosure 10U can be accessed. Elevation or other sensors (as well as cameras and rangefinders) can be packaged in replacement head covers or in enclosures attaching externally to the head. Technology long used for wireless rechargeable load sensors in rigging can be employed to communicate with the electronics in the upper enclosure and/or a server/interface without requiring a cabled connection.

Absolute (or incremental) position sensing can also be added to a fixture by providing a pattern on one surface scanned by a sensor(s) on another surface moving relative to it.

### Power and Data Distribution

The choice of a twist-lock or other connector for distributing power to automated and LED fixtures began in an era when most commercially-available such fixtures were supplied with a 6-foot line cord to be terminated with a customer's choice of connector. Different users employ different connectors, including for the same voltages. Fixtures with switching power supplies are capable of operating at different voltages, which are distributed by users with different connectors. For these (and other reasons) there was appeal in finding a universal power connector type, one not limited to use at a specific voltage, comparable to the “IEC” connector found on consumer and other electronics, and locking. Neutrik of Schaan, Lichtenstein met the requirement with a “POWERcon” connector, widely adopted.

One drawback of the POWERcon is that a female cable connector will not mate with a male cable connector. Therefore, cables cannot be extended by simply chaining them together, at least not without an intermediate adaptor.

Subsequently, Neutrik introduced a “True-1” connector, not intermateable with the POWERcon, but permitting the mating of cord-mounted connectors of the same model.

While both connector types allow unplugging the line cord from the fixture, both for convenience in handling and to allow for substituting line cords with different male power inlet connector types, the line cord, therefore, be undesirably misplaced in handling.

Early automated fixtures dedicated one cable to each fixture, connecting it with a splitter box, which, in turn, was supplied with power and data for a plurality of fixtures via a trunk cable. Modern generic distribution systems seek to share a circuit among several fixtures, within the limits of their own power draw versus the total supply circuit capacity, in order to reduce the quantity of cabling and distribution equipment required.

In FIG. 12, fixtures 19A-19C are illustrated with such separable line cords (e.g., 19AL and 19CL). In FIG. 13, fixtures 19D and 19E have fixed line cords.

In either eventuality, a power “twofer” (e.g., 20D), which parallels two output connectors to a single input connector, supplies two fixtures from one feed. Where the fixtures are spaced apart, for example, on a truss or pipe, an extension cable (“jumper”) (e.g., 20C or 20-E) might be required to extend to the next fixture.

In control data distribution, the use of an analogous “Y” adaptor is not permitted, as the “stubs” created are a potential source of reflections that degrade data integrity. Data cabling must be “daisy-chained” from receiver to receiver, each fixture or other consumer providing one each male and female receptacle, internally paralleled (as is illustrated here) in the case of data “jumpers” 21B and 21C.

As will be seen in FIG. 12, sharing power among three fixtures 19A, 19B, and 19C from a common supply 20A, requires two “twofers” 20B and 20D; two power extensions/“jumpers” 20C and 20E; and the mating of fourteen connectors—plus the three connections of line cords to the fixtures. With, in some cases, hundreds of lighting fixtures in a single system, the cost in parts and labor, as well as the potential for failures at each connection, are substantial.

Some fixtures offer, for power, a female receptacle of the same type as the power inlet (both either a POWERcon or a True-1) allowing “daisy-chaining” multiple fixtures together. To do so, extension cables with the corresponding connectors are required, and in a variety of lengths, and of both types.

The need for multiple cables and for different cable types to share power among multiple fixtures or other consumers increases the complexity of the distribution system; the number of components and potential points of omission or failure; and assembly labor. All have various associated costs. Such cabling and related components can undesirably add bulk to the fixture position and can require restraint with tape or tie-line (as illustrated in FIG. 4B) for appearance, to prevent their obstructing fixture motion, and their catching or being caught by workers or by other equipment in transport and handling—further increasing labor. In many situations, fixtures on multiple power (if not data) feeds are intermixed along a supporting structure, increasing the complexity of the cable bundles and their associated costs.

The instant disclosure includes methods and apparatus for sharing power and data among fixtures and other consumers in a more efficient manner.

Referring to FIG. 14, an assembly comprising, in effect, a power twofer, is combined with data cables in a single unit. Two female power connectors 25V and 25M are supplied from a common male power plug 25A. In this Figure, one female connector 25V is of the same type (here, a twist-lock) as the male power connector 25A, and the second female connector 25M is of a different type (here, a POWERcon or True-1)—although all connectors could be of the same type. Data cable(s) 25D and 25I connect male data connector 25C with female data connector 25L. Data cable(s) 25K and 25X connect male data connector 25N with female data connector 25Y.

Paralleling of the two power output connectors to the power input can be performed in the labeled “housing” 25H or at the male power input connector 25A. The data cables can be molded into a housing or, in one possible embodiment, dressed through the parts of a split housing that organizes discrete power and data cables; one then assembled around them. The data and power cables can be gathered together for at least part of their length by any known means, including co-extrusion, adhesion, taping, heat-shrink, sleeving, or banding. Data pair(s) can be disposed within a common jacket with power conductors and “broken out” for termination in separate connectors near their ends, or by a pendant with the connector for one (typically data) issuing from the backshell of the connector for the other.

FIGS. 15-17 illustrate an improvement, in which one set of power and data connectors are incorporated in a “housing” 26H, here, power receptacle 26V and data receptacle 26Y.

Various of the advantages of embodiments such as those illustrated will be explored below.

### Improved Data Distribution

As previously noted, the use of simple “Y” cables (as data “twofers”) is not accepted practice for data transmission in the application, because of reflections resulting from the “stubs” produced. As a result, connecting a plurality of data consumers to a common data stream has required “daisy-chaining” them, by using jumpers between a data outlet/thru receptacle on one unit and the data input receptacle on the next. This results in large numbers of connections to be made, as well as loss of data to all downstream consumers if both connections are not made at any upstream consumer. Internally, the two data receptacles on a DMX-512 consumer are generally simply paralleled.

An improvement parallels the data input cable feeding a fixture or other data consumer to a data “thru” cable feeding the next consumer at the contacts of the female connector that supplies the first consumer, rather than relying upon a prior art connection through the first consumer (hereafter, referred to as “touch and go”).

FIG. 18 illustrates the distinction; combining an elevation of a power distribution unit as illustrated in FIG. 14, with a diagram of its modified data signal wiring.

As will be seen, a data pair 27D connects the male data input connector 27C with female data connector 27L. Unlike prior Figures and practice, the data pair supplying female data connector 27Y is not supplied from another male connector, which couples data from input 27C only via a feed-thru connector on an intermediate fixture or other consumer. Instead, the extending data pair is terminated to the incoming data pair substantially at the contacts 27LL of female connector 27L. Because the data feed-thru on most consumers is a passive bridge between adjacent male and female connectors, the disclosed connection substantially in the connector 27L supplying data to the consumer is functionally the same as a feed-thru, and the additional conductors beyond the new connection is of insufficient length to significantly impact data integrity. Suitable cable types having two data pairs in a jacket are widely available, such that a single cable can be used for both the data pairs to and from such a connection.

The advantages of the disclosed improvement include a dramatic reduction in cost, by eliminating the second connector and reducing cable; the elimination of the operating labor step required to separate and identify two cables/connectors at each data consumer and plug both; and improved data integrity, because whether or not a consumer is plugged into any intermediate connector has no impact upon whether data is present for other consumers downstream of it.

The benefits of the disclosed “touch and go” data distribution can also be offered in either single data-only versions as well as in data festoons.

FIG. 19A illustrates a data-only version as well as a topology in which the extension is routed back from connector 28L to the male connector 28C, for thru-connection to connector 28Y.

FIG. 19B illustrates a “festoon” that allows a large number of consumers to be supplied from a common data input with the advantages cited.

FIG. 20 illustrates the combined power and data distribution unit seen in prior Figures employing the improved data distribution method.

As seen in FIG. 20, the “touch and go” data approach, when applied to the illustrated power distribution unit, offers a further simplification.

As seen in FIGS. 21A and 21B, in comparison with FIGS. 12 and 13, the disclosed simplifies the sharing of both power and data among a plurality of fixtures or other consumers. As seen in FIG. 21B, such units can be chained together. They can be built with power and data inlet cables of different lengths to accommodate different mounting centers/distances between fixtures. Standard twist-lock (or other power connector) and XLR data cables can be used in extensions.

FIGS. 22A-22C illustrate a variant that employs power and data inlet connectors rather than pigtails with plugs. As seen in unit 34T in FIG. 23A, this allows inserting such units in runs of prior art power and data extensions (e.g., 20C and 21B) of any length, to suit spacing requirements.

An important advantage of the invention is that unit can, as illustrated in FIG. 23B, also be used as a line cord for a fixture or other consumer. Thus, the buyer can chose to specify (or a vendor supply) one in lieu of a prior art line cord for the fixture, at modest additional cost, and that single purchase be employed with a fixture either as a line cord, or to share power and data with a downstream consumer more efficiently than prior art methods as described. It will be understood that embodiments that incorporate data with power have been illustrated, but that variants can be employed which are for power only, including in applications in which consumers do not require data, or where data is supplied separately, in the prior art manner.

Connectors on the power inlet, pendant, and output can be of different types and configurations. Embodiments are possible in which connectors can be field-exchanged to suit requirements and that can also provide adaption/conversion from one connector type to another. FIGS. 24A-D illustrate split housings 36HC, 36HD, and 37 HR having different functions that can be assembled in different combinations. FIGS. 24B-24D illustrate a variant in which the data wiring and connector(s) are disposed in a separate sub-module, to allow ready choice of different data connector type (e.g., 3-pin versus 5-pin XLR) and for isolation.

FIGS. 24A illustrate a variant intended for when the consumer is one having a fixed line cord, whose unneeded length would add bulk to cabling if used with a unit such as in the prior Figures. In such cases, with the variant in this Figure, only the data extension 36L is needed and the consumer's line cord can reach the receptacle 36M on the housing. The housing shape is also illustrated with curved surfaces to nest against the pipe or tubing on which they will often be used.

The disclosure presents only some possible embodiments of the inventions, which should not be understood as so limited.

1. A spotlight, said spotlight at a location, and comprising:
a light source having a luminous output,
an aperture,
a beam forming means, said beam forming means capable of imaging said aperture and having a motorized focal length adjustment variable in response to a first input value,
a light varying means, said light varying means capable of adjusting the intensity of said beam in response to a second input value,
a beam directing means, said beam directing means responsive to input values received from a manual two axis input device at a location remote from said spotlight and capable of varying the azimuth and elevation of said beam to direct it towards a subject at a least one and a different distance from said spotlight,
means responsive to changes in said elevation from so directing compensating said intensity of said beam to maintain substantially the same light level in said beam at said one and said different distance.
